(19) United States
(12) Patent Application Publication
(10) Pub. No.: US 2023/0017393 A1
(43) Pub. Date: Jan. 19, 2023

(54) TIRE PRESSURE DETECTION SYSTEM WITH SEPARATED ANTENNAS

(71) Applicant: SHIH-CHIN CHO, TAIPEI CITY (TW)

(72) Inventor: SHIH-CHIN CHO, TAIPEI CITY (TW)

(21) Appl. No.: 17/378,757

(22) Filed: Jul. 18, 2021

(51) Int. Cl. B60C 23/04; G01L 17/00

(52) U.S. Cl. CPC B60C 23/0452; B60C 23/0476; G01L 17/00; H04W 4/80

(57) ABSTRACT

A tire pressure detection system with separated antennas includes a detection end 10 and a receiving end. The detection end includes tire pressure detectors to detect the tire to obtain the tire status. The tire pressure detectors outputs the tire status, and the information of the tire status is output in the form of radio frequency signal and Bluetooth signal to the tire-pressure receiving device, the audio-video device and the mobile device so that the users are acknowledged about the information of the tire including tire pressure and tire temperature.

### BACKGROUND OF THE INVENTION

### I. Fields of the Invention

The present invention relates to a tire pressure detection system, and more particularly, to a tire pressure detection system with separated antennas, and the information of the tire status is sent to a remote receiving device.

### 2. Descriptions of Related Art

The conventional tire pressure detector only has a single wireless signal transmission mode in the form of radio frequency signal Or Bluetooth signal. The signals of the detected tire are sent to a receiving device on the vehicle so that the users is acknowledged about the pressure and temperature information of the tire.

When the users want to use car audio-visual devices or mobile devices (car audio-video devices and mobile devices hereinafter referred to as external devices) as a reading/displaying device for displaying the tire information. However, because the detected signals are different, so that a signal receiving converter is required to be installed in the car. The signal receiving converter not only occupies a certain space in the car, but also requires additional power supply which usually occupies the cigarette lighter power supply socket or power socket, which has its problems to be overcome.

The present invention intends to provide a tire pressure detection system with separated antennas to eliminate shortcomings mentioned above.

### SUMMARY OF THE INVENTION

The present invention relates to a tire pressure detection system with separated antennas and comprises a detection end and a receiving end. The receiving end includes a receiving device, an audio-video device and a mobile device.

The detection end includes multiple tire pressure detectors, and each tire pressure detector has a tire status detection unit, a main control unit, a radio frequency circuit and a Bluetooth circuit. The main control unit is electrically connected to the tire status detection unit, the radio frequency circuit and the Bluetooth circuit. The tire status detection unit continuously detects the tire status, and the main control unit transfers the information of the tire status into control transferring signal. The main control unit sends the control transferring signal out.

The radio frequency circuit includes a radio frequency control unit, a radio frequency matching unit and a radio frequency antenna. The radio frequency matching unit is electrically connected with the radio frequency control unit and the radio frequency antenna. The radio frequency control unit receives the control transferring signal and transfers the control transferring signal into radio frequency single. The radio frequency matching unit adjusts the control transferring signal into a pre-set radio frequency impedance matching to obtain a maximum work transferring. The radio frequency antenna sends the radio frequency single to any one or more than two of the receiving deice, the audio-video device and the mobile device by a corresponding frequency band so as to display the tire status.

The Bluetooth circuit includes a Bluetooth control unit, a Bluetooth matching unit and a Bluetooth antenna. The Bluetooth matching unit is electrically connected to the Bluetooth control unit and the Bluetooth antenna. The Bluetooth control unit receives the control transferring signal and transfers the control transferring signal into Bluetooth signal. The Bluetooth matching unit transfers the control transferring signal into a pre-set Bluetooth impedance matching to obtain a maximum work transferring. The Bluetooth antenna sends the Bluetooth single to any one or more than two of the receiving deice, the audio-video device and the mobile device by a corresponding frequency band so as to display the tire status.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates a block diagram of the lire pressure detection system with separated antennas of the present invention;

FIG. 2 illustrates that the tire pressure detector wirelessly sends transferring signals to the tire-pressure receiving device, the audio-video device and the mobile device;

FIG. 3 illustrates that the tire pressure detector is connected with the tire-pressure receiving device, the audio-video device and the mobile device;

FIG. 4 illustrates a block diagram of the tire pressure detector of the present invention;

FIG. 5 shows that the tire-pressure receiving device and the audio-video device receive the tire status from the tire pressure detector, and

FIG. 6 shows the steps of the tire pressure detection system with separated antennas of the present invention.

### DETAILED DESCRIPTION OF THE PREFERRED EMBODIMENT

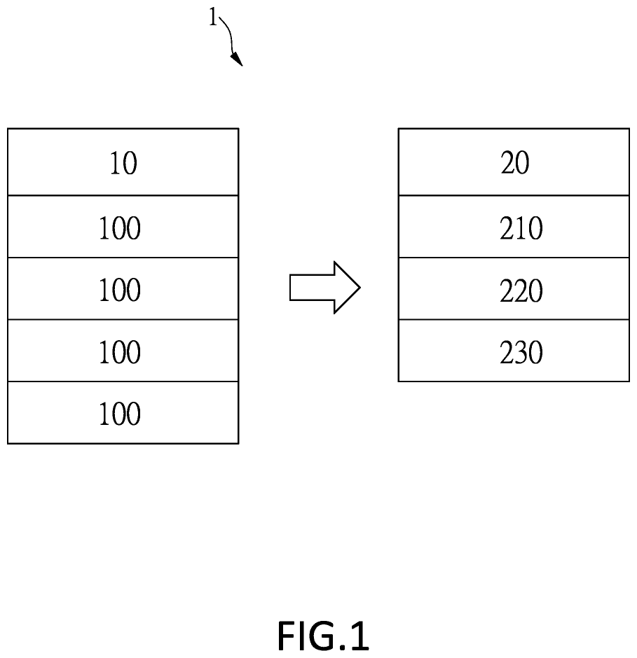

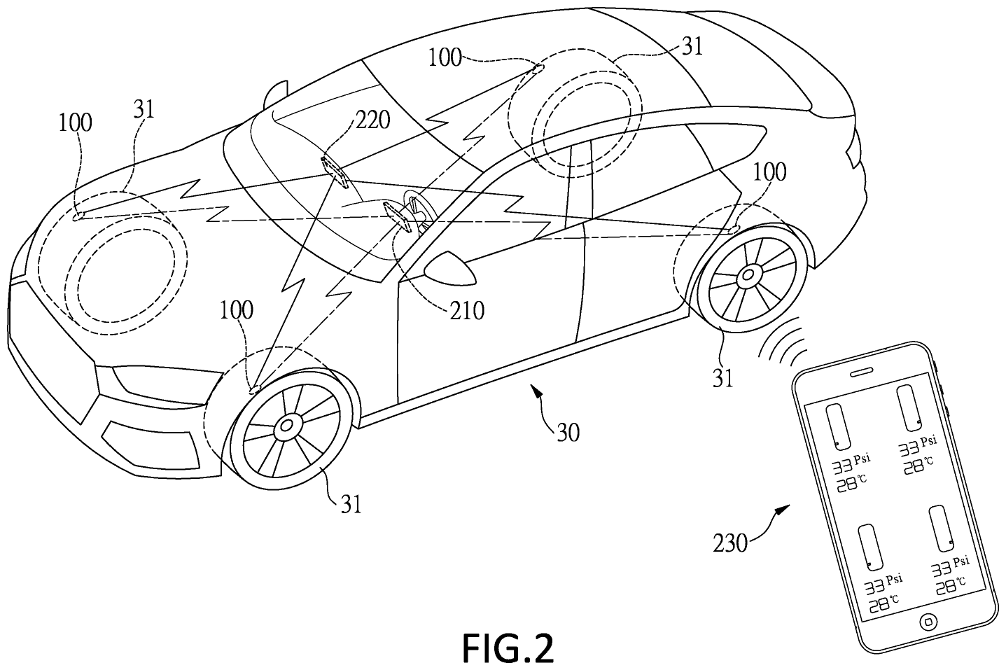

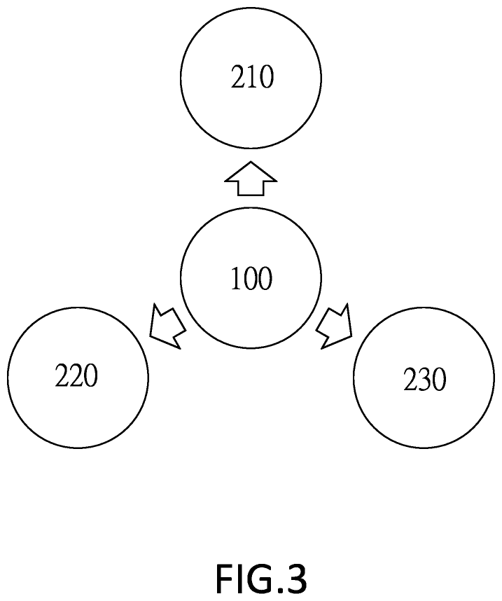

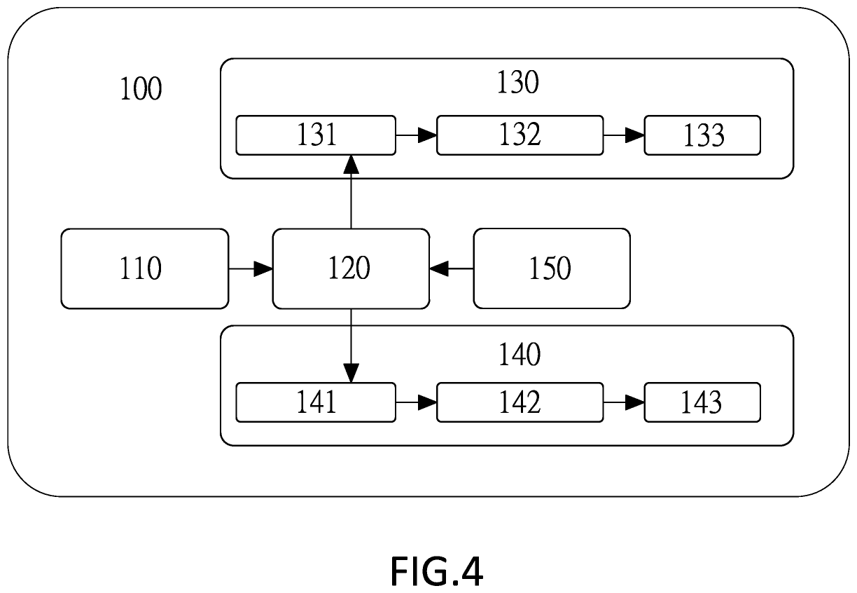

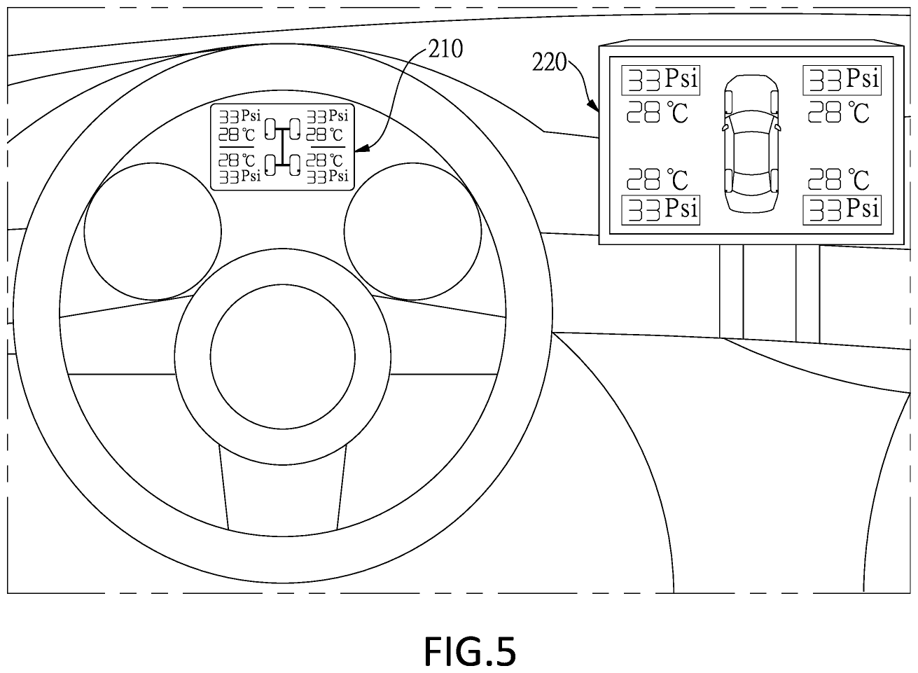

Referring to FIGS. 1 to 5, the tire pressure detection system with separated antennas 1 of the present invention comprises a detection end 10 and a receiving end 20. The detection end 10 includes multiple tire pressure detectors 100, In this embodiment, there are four tire pressure detectors 100 respectively installed to four tires 31 of a vehicle 30. The receiving end 20 includes a tire-pressure receiving device 210, an audio-video device 220 and a mobile device 230. The tire-pressure receiving device 210 is built in the vehicle 30 by the manufacturers. The audio-video device 220 can be a built-in equipment or an externally installed device. The mobile device 230 can be the users' small phones.

Each tire pressure detector 100 includes a tire status detection unit 110, a main control unit 120, a radio frequency circuit 130 and a Bluetooth circuit 140. The main control unit 120 is electrically connected to the tire status detection unit 110, the radio frequency circuit 130 and the Bluetooth circuit 140. The tire status detection unit 110 continuously detects the tire status of each tire 31. The main control unit 120 transfers the information of the detected tire status into a control transferring signal, and the main control unit 120 sends the control transferring signal out. The tire status includes tire pressure and tire temperature.

The radio frequency circuit 130 includes a radio frequency control unit 131, a radio frequency matching unit 132 and a radio frequency antenna 133. The radio frequency matching unit 132 is electrically connected with the radio frequency control unit 131 and the radio frequency antenna 133. The radio frequency control unit 131 receives the control transferring signal and transfers the control transferring signal into a radio frequency single. The radio frequency matching unit 132 adjusts the control transferring signal into a pre-set radio frequency impedance matching to obtain a maximum work transferring. The radio frequency antenna 133 sends the radio frequency single to any one or more than two of the tire-pressure receiving device 210, the audio-video device 220 and the mobile device 230 by a corresponding frequency band so as to display the tire status.

The Bluetooth circuit 140 including a Bluetooth control unit 141, a Bluetooth matching unit 112 and a Bluetooth antenna 143. The Bluetooth matching unit 142 is electrically connected to the Bluetooth control unit 141 and the Bluetooth antenna 143. The Bluetooth control unit 141 receives the control transferring signal and transfers the control transferring signal into a Bluetooth signal. The Bluetooth matching unit 142 transfers the control transferring signal into a pre-set Bluetooth impedance matching to obtain a maximum work transferring. The Bluetooth antenna 143 sends the Bluetooth single to any one or more than two of the tire-pressure receiving device 210, the audio-video device 220 and the mobile device 230 by a corresponding frequency band so as to display the tire status.

When in use, the detection end 10 detects the tire status of the tire 31, such as the tire pressure and the tire interior temperature, by the tire status detection unit 110 of the tire pressure detector 100. The main control unit 120 sends the detected information to the receiving end 20 in the form of radio frequency signal and Bluetooth signal by radio frequency circuit 130 and the Bluetooth circuit 140. The tire status is then displayed by the tire-pressure receiving device 210, the audio-video device 220 and the mobile device 230.

It is noted that the tire pressure detector 100 is able to provide two types of signals which are the radio frequency signal and the Bluetooth signal, to not only the tire-pressure built-in receiving device 210, also the tire status cab display on the audio-video device 220 and the mobile device 230 without extra signal converters so as to improve the problems of the conventional tire pressure detector system.

Specifically, the radio frequency signal is a 315 MHz and 433.92 MHz transferring signal, and the Bluetooth signal is a 2.4 GHz transferring signal.

The main control unit 120 sends the control transferring signal to the radio frequency control unit 131 and the Bluetooth control unit 141 by one of or two of a pre-set sequence, a pre-set number of times and a pre-set of time.

In addition, each of the tire pressure detectors 100 includes a calling unit 150 which is electrically connected to the main control unit 120.

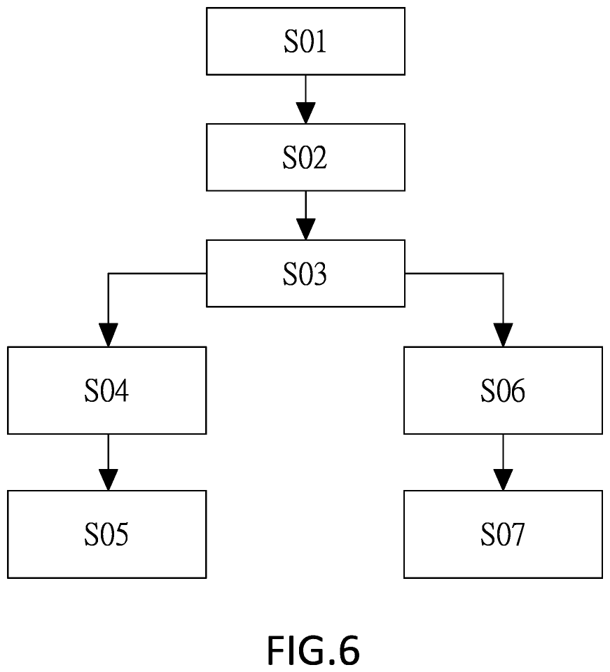

As shown in FIG. 6, the operation of the tire pressure detection system with separated antennas 1 includes the following steps:

Step S01: the calling unit 150 of the tire pressure detector 100 is activated from hibernation mode into monitoring mode:

Step S02: after the tire detection detector 100 is activated, the main control unit 120 demands the tire status detection unit 110 to continuously detect the tire pressure and the interior temperature of the tire 31 so as to obtain information of the tire status, and the information of the tire status is transferred into control transferring signal and sent out;

Step S03: the main control unit 120 sends the control transferring signal to the radio frequency control unit 131 and the Bluetooth control unit 141 by two of a pre-set sequence, a pre-set number of times and a pre-set of time;

Step S04: when the signal sent out is a radio frequency signal, the radio frequency control unit 131 receives the control transferring signal and transfers the control transferring signal into a radio frequency single, and the radio frequency matching unit 132 adjusts the control transferring signal into a pre-set radio frequency impedance matching;

Step S05: the radio frequency antenna 133 transfers the pre-set radio frequency impedance matching to obtain a maximum work transferring, the radio frequency antenna 133 sends the radio frequency single to any one or more than two of the tire-pressure receiving device 210, the audio-video device 220 and the mobile device 230 by a corresponding frequency band so as to display the tire status;

Step 06: when the signal sent out is a Bluetooth signal, the Bluetooth control unit 141 receives the control transferring signal and transfers the control transferring signal into Bluetooth signal, the Bluetooth matching unit 142 transfers the control transferring signal into a pre-set Bluetooth impedance matching;

Step 07: the Bluetooth antenna 143 transfers the pre-set Bluetooth impedance matching tO obtain a maximum work transferring, the Bluetooth antenna 143 sends the Bluetooth single to the tire-pressure receiving device 210, the audio-video device 220 and the mobile device 230 by a corresponding frequency band so as to display the tire status.

While we have shown and described the embodiment in accordance with the present invention, it should be clear to those skilled in the art that further embodiments may be made without departing from the scope of the present invention.

What is claimed is:

1. A tire pressure detection system with separated antennas comprising:
a detection end and a receiving end, the receiving end including a tire-pressure receiving device, an audio-video device and a mobile device;
the detection end including multiple tire pressure detectors, each tire pressure detector having a tire status detection unit, a main control unit, a radio frequency circuit and a Bluetooth circuit, the main control unit electrically connected to the tire status detection unit, the radio frequency circuit and the Bluetooth circuit, the tire status detection unit continuously detecting a tire status, the main control unit transferring an information of the tire status into a control transferring signal, the main control unit sending the control transferring signal out;
the radio frequency circuit including a radio frequency control unit, a radio frequency matching unit and a radio frequency antenna, the radio frequency matching unit electrically connected with the radio frequency control unit and the radio frequency antenna, the radio frequency control unit receiving the control transferring signal and transferring the control transferring signal into a radio frequency single, the radio frequency matching unit adjusting the control transferring signal into a pre-set radio frequency impedance matching to obtain maximum work transferring, the radio frequency antenna sending the radio frequency single to any one or more than two of the tire-pressure receiving device, the audio-video device and the mobile device by a corresponding frequency band so as to display the tire status, and
the Bluetooth circuit including a Bluetooth control unit, a Bluetooth matching unit and a Bluetooth antenna, the Bluetooth matching unit electrically connected to the Bluetooth control unit and the Bluetooth antenna, the Bluetooth control unit receiving the control transferring signal and transferring the control transferring signal into Bluetooth signal, the Bluetooth matching unit transferring the control transferring signal into a pre-set Bluetooth impedance matching to obtain maximum work transferring, the Bluetooth antenna sending the Bluetooth Single to any One or more than two of the tire-pressure receiving device, the audio-video device and the mobile device by a corresponding frequency band so as to display the tire status.

2. The tire pressure detection system with separated antennas as claimed in claim 1, wherein the radio frequency signal is a 315 MHz and 433.92 MHz transferring signal, the Bluetooth signal is a 2.4 GHz transferring signal, the tire status includes tire pressure and tire temperature.

3. The tire pressure detection system with separated antennas as claimed in claim 1, wherein each of the tire pressure detectors includes a calling unit which is electrically connected to the main control unit.

4. The tire pressure detection system with separated antennas as claimed in claim 1, wherein the main control unit sends the control transferring; signal to the radio frequency control unit and the Bluetooth control unit by a pre-set sequence.

5. The tire pressure detection system with separated antennas as claimed in claim 1, wherein the main control unit sends the control transferring signal to the radio frequency control unit and the Bluetooth control unit by a pre-set number of times.

6. The tire pressure detection system with separated antennas as claimed in claim 1, wherein the main control unit sends the control transferring signal to the radio frequency control unit and the Bluetooth control unit by a pre-set of time.

7. The tire pressure detection system with separated antennas as claimed in claim 1, wherein the main control unit sends the control transferring signal to the radio frequency control unit and the Bluetooth control unit by one of or two of a pre-set sequence, a pre-set number of times and a pre-set of time.
